(19) United States
(12) Patent Application Publication
(10) Pub. No.: US 2024/0323039 A1
(43) Pub. Date: Sep. 26, 2024

(54) GROUP INTERACTION METHOD AND APPARATUS, AND DEVICE AND STORAGE MEDIUM

(71) Applicant: Beijing Zitiao Network Technology Co., Ltd., Beijing (CN)

(72) Inventor: Siyao JIN, Beijing (CN)

(21) Appl. No.: 18/574,189

(22) PCT Filed: Jul. 15, 2022
(86) PCT No.: PCT/CN2022/105907

§ 371 Date: Dec. 26, 2023

(30) Foreign Application Priority Data
Jul. 22, 2021 (CN) 202110833158.7

(51) Int. Cl. H04L 12/18

(52) U.S. Cl. CPC H04L 12/1818; H04L 12/1822

(57) ABSTRACT

Disclosed are a group interaction method and apparatus, and a device and a storage medium. The group interaction method comprises: displaying a preset reminder control in a group session interface, wherein the preset reminder control is configured for triggering a relevant operation of a preset reminder event, and the preset reminder event comprises reminding a target group member in a group to complete a predetermined operation; receiving a triggering on the preset reminder control; and responding to the triggering.

The present application claims priority from the Chinese patent application No. 202110833158.7, filed with the China Patent Office on Jul. 22, 2021, the entire contents of which are incorporated herein by reference.

### TECHNICAL FIELD

The present disclosure relates to the field of Internet technology, and in particular, to a group interaction method and apparatus, device and storage medium.

### BACKGROUND

With the rapid development of Internet technology, watching or browsing online resource works such as live videos, short videos, novels and comics has become one of the main leisure and entertainment ways of people, and users can communicate with resource publishers through groups established by corresponding platforms. However, the form of interaction between the users and the resource publishers is relatively single, and the interaction efficiency and the reminder effect need to be improved.

### SUMMARY OF THE INVENTION

The present disclosure provides a group interaction method and apparatus, a storage medium and a device, which can solve the problem of low interaction efficiency in a group.

The present disclosure provides a group interaction method, comprising:
displaying a preset reminder control in a group session interface, wherein the preset reminder control is configured for triggering a relevant operation of a preset reminder event, and the preset reminder event comprises reminding a target group member in a group to complete a predetermined operation;
receiving a triggering on the preset reminder control; and
responding to the triggering.

The present disclosure provides a group interaction apparatus, comprising:
a reminder control display module configured to display a preset reminder control in a group session interface, wherein the preset reminder control is configured for triggering a relevant operation of a preset reminder event, and the preset reminder event comprises reminding a target group member in a group to complete a predetermined operation;
a triggering receiving module configured to receive a triggering on the preset reminder control; and
a triggering responding module configured to respond to the triggering.

The present disclosure provides a computer-readable storage medium on which a computer program is stored, wherein the program, when executed by a processor, implements the group interaction method described above.

The present disclosure provides an electronic device, comprising a memory, a processor, and a computer program stored in the memory and executable on the processor, wherein the processor, when executing the computer program, implements the group interaction method described above.

### BRIEF DESCRIPTION OF THE DRAWINGS

FIG. 1 is a schematic flowchart of a group interaction method provided in an embodiment of the present disclosure;

FIG. 2 is a schematic flowchart of a further group interaction method provided in an embodiment of the present disclosure;

FIG. 3 is a schematic diagram of a group session interface provided in an embodiment of the present disclosure;

FIG. 4 is a schematic flowchart of a further group interaction method provided in an embodiment of the present disclosure;

FIG. 5 is a schematic diagram of a further group session interface provided in an embodiment of the present disclosure;

FIG. 6 is a schematic flowchart of a further group interaction method provided in an embodiment of the present disclosure;

FIG. 7 is a schematic diagram of a further group session interface provided in an embodiment of the present disclosure;

FIG. 8 is a block diagram of a group interaction apparatus provided in an embodiment of the present disclosure;

FIG. 9 is a block diagram of an electronic device provided in an embodiment of the present disclosure.

### DETAILED DESCRIPTION

Embodiments of the present disclosure will be described below with reference to the drawings. While some embodiments of the present disclosure are shown in the drawings, the present disclosure can be implemented in a plurality of forms, and these embodiments are provided for understanding the present disclosure. The drawings and embodiments of the present disclosure are for illustration purposes only.

A plurality of steps recited in method embodiments of the present disclosure may be performed in different orders, and/or performed in parallel. Moreover, the method embodiments may include additional steps and/or omit performing the illustrated steps. The scope of the present disclosure is not limited in this respect.

The term “including” and variations thereof as used herein are intended to be open-ended, i.e., “including but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the following description.

The concepts “first”, “second”, and the like in the present disclosure are only used for distinguishing different apparatuses, modules or units, and are not used for limiting the order or interdependence of the functions performed by the apparatuses, modules or units.

The references to the modifications “one” and “a plurality of” in the present disclosure are intended to be illustrative rather than limiting, and one of ordinary skill in the art will appreciate that they should be understood as “one or more” unless indicated otherwise in the context.

The names of messages or information exchanged between apparatuses in the embodiments of the present disclosure are for illustrative purposes only, and are not intended to limit the scope of the messages or information.

In the following embodiments, optional features and examples are simultaneously provided in each embodiment, and a plurality of features described in the embodiments may be combined to form a plurality of optional solutions, and each numbered embodiment should not be regarded as only one technical solution.

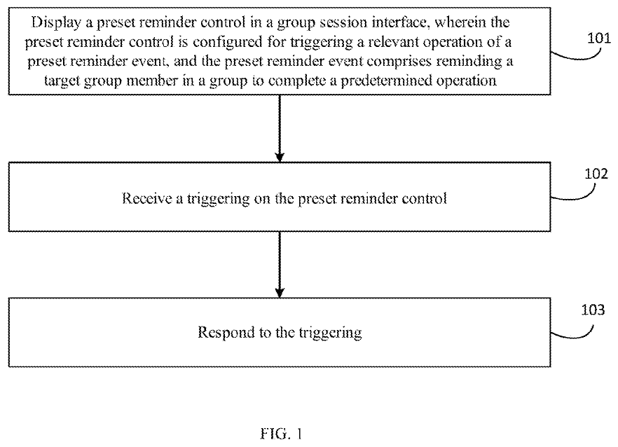

FIG. 1 is a schematic flowchart of a group interaction method provided in an embodiment of the present disclosure, which method can be executed by a group interaction apparatus, wherein the apparatus can be implemented by software and/or hardware, and can be generally integrated in an electronic device. As shown in FIG. 1, the method comprises:

Step 101, displaying a preset reminder control in a group session interface, wherein the preset reminder control is configured for triggering a relevant operation of a preset reminder event, and the preset reminder event comprises reminding a target group member in a group to complete a predetermined operation.

In the embodiment of the present disclosure, the group may include at least two group members, that is, at least two users. The group session interface may be an interface in a preset application, and the preset application may be used to provide a group session function. The type of the preset application is not limited in this embodiment, and the preset application may be installed in an electronic device such as a mobile phone, a tablet computer, or a computer, and a user may register an account in the preset application and log it in.

Illustratively, the predetermined operation may include a releasing a new work, opening a live broadcast, releasing specified work or releasing a predetermined number of works, etc., and may also be understood as releasing a new resource, and the predetermined operation may also include other operations, such as adding a new product to a shop window or adding a new member to the group, etc. The works can also be called resources, which can be information or data in various forms such as pictures, text, audio or video. The types of the resources are not limited in this embodiment, and they are generally presented in the form of works, such as live broadcast videos, short videos, novels, comics and other online resource works. The user can upload works to be released to a server corresponding to the preset application, and the works are issued by the server to the preset applications used by other users to be displayed. Taking an application scenario as an example, the preset application comprises a short video application, the resource includes a short video, then the short video application is configured for playing the short video released by the user, the video author can upload the short video work captured by himself to a short video platform, the short video platform can issue the short video work to the short video applications used by other users for playback, and then the other users can watch the short video work released by the video author. Taking another example, the preset application comprises a live broadcast application, the resource comprises a live video stream, then the live broadcast application is configured for playing real-time video streams pushed by an anchor, the anchor can push the video streams captured in real time to a live broadcast platform, and the live broadcast applications used by other users can pull corresponding video streams from the live broadcast platform for the users to watch.

In an embodiment, in order to facilitate communication between a resource publisher and users who pay attention to the resource publisher (which can be understood as fans of the resource publisher), a group can be created in a preset application, group members can perform a conversation in the group, the creator of the group (i.e., group owner) may be the resource publisher himself or a fan of the resource publisher, and a target group member may be understood as the resource publisher. In order to facilitate understanding, subsequent explanation is made below by taking an example in which a group owner is a target group member, and fans are other group members (the fans in the following refer to fans in a group, generally excluding fans outside the group), and at this time the group can also be understood as a fan group.

When the group owner does not update works for a long time, the fans usually have the intention of urging or reminding him to update as soon as possible. In the embodiment of the present disclosure, the preset reminder control for triggering the relevant operation of the preset reminder event can be displayed in the group session interface, so as to facilitate the fans to urge the group owner to update in the group, that is, to remind the group owner to complete the predetermined operation.

In the embodiment of the present disclosure, the group session interface may be a group session window, and there is no limitation on the display form, display position, display timing, display amount, and the like of the preset reminder control. Illustratively, the preset reminder control may be displayed in the group session interface in the form of a virtual button, and copyrighting on the button can be set according to the actual situation; the preset reminder control may be displayed at a preset position in the group session interface, and the number of the preset positions may be one or more, for example, the preset position may include the top of the group session interface (for example, above a session content display area), and may also include a position in the session content display area, such as a group card preset reminder control located in a message card.

Illustratively, the preset reminder control is configured for triggering the relevant operation of the preset reminder event, where the relevant operation may include operations such as initiating, participating, canceling, viewing, or replying, which can be set according to actual requirements.

Optionally, in order to facilitate management of a preset reminder event, a reminder period may be set. In the reminder period, a preset reminder event is opened, for example, in the reminder period, fans in a group can initiate or participate in the preset reminder event in the group; and outside the reminder period, the preset reminder event is shielded, for example, outside the reminder period, the fans in the group cannot initiate or participate in the preset reminder event in the group. The reminder period can be set according to actual requirements, for example, the starting point of the reminder period may be when a preset length of time (for example, 6 hours) has elapsed since the group owner last completed the predetermined operation, and the ending point of the reminder period may be when the group owner completes the predetermined operation. It may also be understood as when the group owner completes the predetermined operation, the current preset reminder event is ended, and timing is restarted.

Optionally, a reminder function for completing the predetermined operation is added to the group session interface. When the function of the preset reminder event is just put into use, guidance information can be displayed in the group session interface for prompting the user how to initiate or participate in the preset reminder event. For example, the guidance information may be displayed in the form of a bubble near the preset reminder control.

Step 102, receiving a triggering on the preset reminder control.

Illustratively, a user's triggering on the preset reminder control is received based on the group session interface, and there is no limitation on the operation mode of the triggering in this embodiment, which may be, for example, a click, a long press, a double click, or the like.

Step 103, responding to the triggering.

Illustratively, after receiving the triggering on the preset reminder control, a response to the triggering can be made in time, and there is no limitation on the responding mode in this embodiment, which may be determined according to a current scene, an identity of a user who inputs the triggering, an input mode of the triggering, a current display state of the preset reminder control, or other relevant factors.

According to the group interaction solution provided in the embodiment of the present disclosure, the preset reminder control is displayed in the group session interface, wherein the preset reminder control is configured for triggering the relevant operation of the preset reminder event, the preset reminder event comprises reminding a target group member in the group to complete the predetermined operation, receiving the triggering on the preset reminder control, and responding to the triggering. By adopting the technical solution described above, the group members can participate in the preset reminder event in the group session interface by triggering the preset reminder control, and the target group member in the group can be reminded to complete the predetermined operation, so that the form of interaction among the group members can be enriched, the interaction efficiency can be promoted, and the reminding effect of the predetermined operation can be improved.

In some embodiments, the responding to the triggering comprises: displaying a reminder content input interface; receiving reminder content based on the reminder content input interface, and generating a group message card corresponding to the preset reminder event according to the reminder content, wherein the group message card includes the reminder content; and displaying the group message card. The advantage of this setting is that the fans are allowed to express their ideas about the preset reminder event in the form of message cards when participating in the preset reminder event, thereby promoting the effect of interaction with the group owner and other fans, and improving the reminding effect.

Illustratively, one or more preset reminder contents can be displayed in the content input interface for current users to directly select, thereby saving user operations and improving the interaction efficiency; and an input box can be displayed, in which users can input self-defined reminder content, so that the messages left are more personalized. When the reminder content is input, an object to which the messages are left can be specified as the group owner by default, for example, by means of “@”.

In some embodiments, the group message card further includes at least one of: a participation serial number corresponding to a group member who inputs the reminder content, a group card preset reminder control, or a current value of a statistical parameter corresponding to the preset reminder event, wherein the preset reminder control includes the group card preset reminder control. The advantage of this setting is that the content in the group message card can be enriched and the ease of interaction can be improved.

In order to facilitate the recording of the development state of the preset reminder event, the corresponding statistical parameter can be set, which may be the number of participants and/or the number of participations, for example.

Illustratively, when the group message card includes a participation serial number corresponding to a group member who inputs the reminder content, since participation serial numbers of a plurality of participants are incremental, the visual effect of building a building can be presented in the group session interface, which helps boost the participation enthusiasm of the group members who do not participate, and promote the interaction effect.

Illustratively, when the group message card contains the preset reminder control, it is convenient for the fans viewing the group messages to conveniently participate in the preset reminder event, and at this time, there may exist two or more preset reminder controls in the group session interface, and the users can select the preset reminder control that needs to be triggered according to their own operation habits.

Illustratively, when the group message card contains the current value of the statistical parameter corresponding to the preset reminder event, it is convenient for the fans viewing the group messages to quickly get aware of the progress of the preset reminder event.

The group message card may further include other content, such as avatars of all or part of the participants (e.g., which may include the initiator and at least one of the latest participants).

In some embodiments, there may further comprise: continuously displaying at least two group message cards corresponding to the preset reminder event in a centralized manner in one area of the group session interface. The advantage of this setting is that the group message cards corresponding to the preset reminder event can be displayed in an aggregated manner, thereby preventing other messages not related to the preset reminder event from being interspersed among multiple group message cards, and improving the viewing efficiency of the group message cards. Optionally, a centralized display button can be set, and by triggering the centralized display button, the group message cards corresponding to the preset reminder event can be displayed in a centralized manner continuously; also, the preset reminder control can be triggered in a preset mode, so that the group message cards corresponding to the preset reminder event are displayed in a centralized manner continuously.

In some embodiments, the responding to the triggering comprises: responding to the triggering according to a current display state of the preset reminder control. The advantage of this setting is that different display states of the preset reminder control can be set, and after receiving the triggering, a targeted response is made according to the different display states, thereby enriching the functions of the preset reminder control and the responding mode of the triggering.

Illustratively, the display state of the preset reminder control may be related to the state or stage where the preset reminder event is, and for example, it may respectively correspond to the preset reminder event being not initiated, the preset reminder event having been initiated, the preset reminder event being ended, and the like; the display state of the preset reminder control may also be related to a login identity corresponding to the group session interface, that is, when the users log in the preset application with different identities, the login identities corresponding to the group session interface are different, for example, the user's log-in with a group-owner identity corresponds to one display state, and the user's log-in with a fan identity corresponds to another display state, and so on; the display state of the preset reminder control may also be related to whether current group members have participated in the preset reminder event, for example, the current group members correspond to one display state before participating in the preset reminder event, and the current group members correspond to another display state after participating in the preset reminder event, and so on. The display state of the preset reminder control may also be related to other factors, and may also be related to the above multiple factors at the same time, which is not limited in this embodiment.

In some embodiments, the responding to the triggering according to a current display state of the preset reminder control comprises: if the current display state of the preset reminder control is non-triggered, in response to the triggering, determining and/or displaying a statistical parameter corresponding to the preset reminder event, wherein the statistical parameter may include the number of participants and/or the number of participations. The advantage of this setting is that when the preset reminder control is not triggered, it is convenient for the users to get aware of the number of participants or the number of participations corresponding to the preset reminder event by triggering the preset reminder control, wherein when the statistical parameter needs to be displayed, the current value of the statistical parameter can be displayed, and there are no limitations on the display position, the display form, and the like in this embodiment.

In some embodiments, the responding to the triggering according to a current display state of the preset reminder control comprises: if the current display state of the preset reminder control is an initial display state, in response to the triggering, determining that the preset reminder event enters an initiating state, and initializing the statistical parameter corresponding to the preset reminder event, wherein the statistical parameter includes the number of participants and/or the number of participations. The advantage of this setting is that fans in a group can conveniently initiate the preset reminder event by triggering the preset reminder control.

Illustratively, in the reminder period, if the preset reminder event is in the non-initiated state, correspondingly, the preset reminder control may be in the initial display state. In the initial display state, the display content (which may be understood as copyrighting) on the preset reminder control may display, for example, “Request updates” for reminding the user that the current preset reminder event is in the non-initiated state, that is, there are no fans to remind the group owner to complete a predetermined operation. Since the group owner generally cannot remind himself to complete the predetermined operation, the preset reminder control in the initial display state can be visible only to the group members except the group owner, namely, the fans. The preset reminder control in the initial display state can also be visible to all group members, namely, when a user logs in a preset application with any identity, the preset reminder control in the initial display state can be displayed in a group session interface, and different response modes can be set according to different login identities. When the preset reminder control is in the initial display state, after a fan inputs the triggering acting on the preset reminder control, the fan can be regarded as an initiator of the preset reminder event, and then it is determined that the preset reminder event enters the initiating state. Optionally, initiation success information may be displayed for feedback to the user.

Illustratively, after it is determined that the preset reminder event enters the initiating state, the number of participants is initialized to 1, and the number of participations is initialized to 1.

In some embodiments, the responding to the triggering according to a current display state of the preset reminder control comprises: if the current display state of the preset reminder control is the initiated display state, in response to the triggering, updating a statistical parameter corresponding to the preset reminder event, wherein the display content corresponding to the initiated display state includes a current value of the statistical parameter. The advantage of this setting is that the heat of participation in the preset reminder event can be reflected more intuitively.

Illustratively, after the initiator triggers the preset reminder control for the first time, the current display state of the preset reminder control may be switched to the initiated display state, and in this state, the display content on the preset reminder control may display, for example, “1 person”, for prompting the users the current number of participants. Optionally, in order to make it convenient for the users to express the intensity of their willingness to be reminded of updates, the preset reminder control can be triggered by the same fan for multiple times, and the number of participations can be increased by 1 after each trigger.

Illustratively, after the preset reminder event enters the initiating state, for the group members other than the initiator, the preset reminder control may also be in the initiated display state, making it convenient for other group members to intuitively know that the preset reminder event has been initiated and the participation of the group members. The display content corresponding to the initiated display state may be directly displayed on the preset reminder control, or may be displayed near the preset reminder control in the form of bubbles, for example, below the preset reminder control, and the bubble content is “XX persons are requesting updates, come and participate”. If a fan triggers the preset reminder control in the initiated display state, the fan can be regarded as a supporter, and the value of the statistical parameter is updated, for example, the number of participants is increased by 1 or the number of participations is increased by 1. For the group owner side, the preset reminder control in the initiated display state can also be displayed, and at this time, the trigger of the preset reminder control by the group owner can be shielded; alternatively, after the group owner triggers the preset reminder control, a group member participation list corresponding to the preset reminder event can be displayed.

In some embodiments, the responding to the triggering according to a current display state of the preset reminder control comprises: if the current display state of the preset reminder control is an ended display state, in response to the triggering, displaying a prompt for the target group member to complete a predetermined operation, wherein if the current moment is in a shielding period corresponding to the preset reminder event, the preset reminder 1 is in the ended display state. The advantage of this setting is that it is convenient to manage preset reminder events, thereby preventing the preset reminder events from being initiated frequently or being in the initiated state for a long time, which may cause unnecessary trouble to the group owner or fans.

Illustratively, a shielding period may be understood as a period outside of the reminder period described above. If the group owner has completed the predetermined operation recently, or the preset reminder event is ended because of the completion of the predetermined operation, in order to provide feedback to an operation of triggering the preset reminder control by a current user and promote the interaction effect, the current user can be reminded to view an operation result of completing the predetermined operation by the group owner, for example, text prompt information “the group owner has just released a new work recently; come and take a look” is displayed; in addition, an access portal of the operation result can be displayed, making it convenient for the current user to quickly view the operation result.

In some embodiments, the responding to the triggering according to a current display state of the preset reminder control comprises: if the current display state of the preset reminder control is triggered, in response to the triggering, displaying a group member participation list corresponding to the preset reminder event, wherein, optionally, item content in the group member participation list includes at least one of group member names, group member avatars, group member ranks, or relationship information between group members and the target group member. The advantage of this setting is that the participation in the preset reminder event can be learnt more comprehensively.

Illustratively, the group member participation list can show related conditions of the fans (including the initiator and the supporter) who have currently participated in the preset reminder event, each participant corresponding to one list item, and an arrangement order of a plurality of list items can be set based on actual conditions, for example, based on the order of participation time, the order of the size of the number of participations, or the closeness with the group owner. Optionally, when the login identities corresponding to the group session interface are different, the item content may also be different; for example, for the fans, the item content includes the group member names and the group member avatars, while for the group owner, the item content includes the group member names, the group member avatars, the group member ranks, and the relationship information between the group members and the target group member.

In some embodiments, there may further comprise: after the preset reminder event enters the initiating state, if the group session interface is not viewed by current group members, displaying first prompt information corresponding to the preset reminder event at a corresponding position of a session entry of the group in a message list. The advantage of this setting is that the group members can be prompted conveniently and effectively with respect to the preset reminder event, making it easier for the group members to know that the preset reminder event has been initiated and then enter the group session interface to view the relevant situation. Illustratively, the first prompt information may include, for example, a red dot that may be displayed at the right end of the session entry and may be multiplexed with a new message reminder function. The first prompt information may also include text prompt information, such as “XX persons are requesting updates; come and take a look”. The login identity corresponding to the message list may include the group owner and may also include the fans.

In some embodiments, there may further comprise: if the login identity corresponding to the group session interface is the target group member, displaying prompt content corresponding to the preset reminder event in the group session interface when a preset condition is satisfied, wherein the preset condition includes when the preset reminder event enters the initiating state, or that a difference value of the current value of the statistical parameter corresponding to the preset reminder event from a historical value when the group session interface was displayed last time is greater than a preset difference threshold value. The advantage of this setting is that when the progress of the preset reminder event changes significantly, extra prompt can be given to the group owner, making it convenient for the group owner to quickly judge whether it is necessary to pay attention to the current situation of preset reminder event in time, wherein the prompt content may be displayed in the form of a floating bar or the like, and the prompt content may include avatars of participants, prompt text, and a quick view button, etc.

In some embodiments, there may further comprise: if the login identity corresponding to the group session interface is the target group member and the preset reminder event is in the initiating state, displaying a viewing control and/or a predetermined operation control in the group session interface, wherein the viewing control is configured for viewing the group members participating in the preset reminder event, and the predetermined operation control includes a trigger portal for completing the predetermined operation. The advantage of this setting is that it is convenient for the group owner to quickly view the participants through the viewing control or to quickly complete the predetermined operation through the predetermined operation control, so as to respond to the preset reminder event in which the fans participate. For example, when the predetermined operation is a resource releasing operation, the predetermined operation control may be a “Go to release” button, and if the resource to be released is a short video, a short video shooting interface or a video selection interface can be entered.

In some embodiments, there may further comprise: after it is detected that the predetermined operation is completed by triggering the predetermined operation control, sending a predetermined operation completion reminder to the group members participating in the preset reminder event. The advantage of this setting is that if the group owner completes the predetermined operation by triggering the predetermined operation control, it is indicated that a timely response to the reminding of the fans is made, and the predetermined operation completion reminder is sent to the fans participating in the reminding in a targeted manner, thereby enhancing the interactivity between the group owner and the fans with regard to the preset reminder event, improving the interaction effect, and strengthening the user stickiness. Illustratively, the predetermined operation completion reminder may be displayed in the group, or may be sent to the fans participating in the reminding through private messages or other notification methods.

In some embodiments, the responding to the triggering comprises: displaying a virtual resource configuration interface; receiving virtual resource configuration information input by a current group member, wherein the virtual resource configuration information is configured for configuring virtual resources transferred from the current group member to the target group member if the target group member completes a predetermined operation by triggering the predetermined operation control. The advantage of this setting is that the fans are allowed to set the virtual resources distributed to the group owner when participating in the preset reminder event, thereby improving the enthusiasm of the group owner for completing the predetermined operation, wherein the virtual resources may be embodied in the form of virtual gifts, points, or the like.

In some embodiments, there may further comprise: after it is detected that the predetermined operation is completed by triggering the predetermined operation control, synchronizing an operation result of the predetermined operation to the group session interface, and displaying second prompt information in the group session interface, which is configured for identifying virtual resources obtained by the target group member based on the predetermined operation, and the virtual resources are transferred to the target group member from the group members participating in the preset reminder event. The advantage of this setting is that if the group owner completes the predetermined operation by triggering the predetermined operation control, it is indicated that a timely response to the reminding of the fans is made, the operation result is synchronized to the group session interface, so that the fans can quickly view the operation result through an access portal, and in addition, the prompt information is displayed to remind the group owner of the virtual resources obtained, thereby improving the interaction effect, activating the group atmosphere, and promoting the enthusiasm of the group owner in releasing new resources. In addition, a preset animation special effect can also be played, which may be a clapping special effect, a glass clinking special effect, a fireworks special effect or a celebration ribbon special effect, etc.

In some embodiments, there may further comprise: if the login identity corresponding to the group session interface is the target group member and the preset reminder event is in the initiating state, displaying a reply control corresponding to the preset reminder event in the group session interface; and after it is detected that the reply control is triggered, receiving reply content input by the target group member, and sending the reply content to the group members participating in the preset reminder event. The advantage of this setting is that if the group owner cannot release new resources temporarily, it is made convenient for the group owner to quickly reply to the participants in a targeted manner by triggering the reply control, thereby appeasing the participants' emotions and improving the interaction effect.

In some embodiments, there may further comprise: if the login identity corresponding to the group session interface is a first group member participating in the preset reminder event, displaying the reply content and a recipient corresponding to the reply content in the group session interface, wherein the recipient is the first group member, and/or the recipient does not comprise a second group member participating in the preset reminder event. Illustratively, the second group member may comprise all or part of the group members of the group participating in the predetermined reminder event other than the first group member. The advantage of this setting is that for individuals participating in the preset reminder event, they are displayed as recipients of the reply content in a targeted manner, thereby improving the interaction effect and enhancing the user stickiness. For example, the reply content viewed in the group session interface for the first group member (assumed to be named A) is “@ A XXXX (reply content)”. In addition, it is possible to avoid, when there are a large number of participants, the interference of displaying numerous recipients to the currently logged-in user, and save display resources on a display interface.

For understanding the embodiment of the present disclosure, the group session interfaces corresponding to different login identities are distinguished and described below.

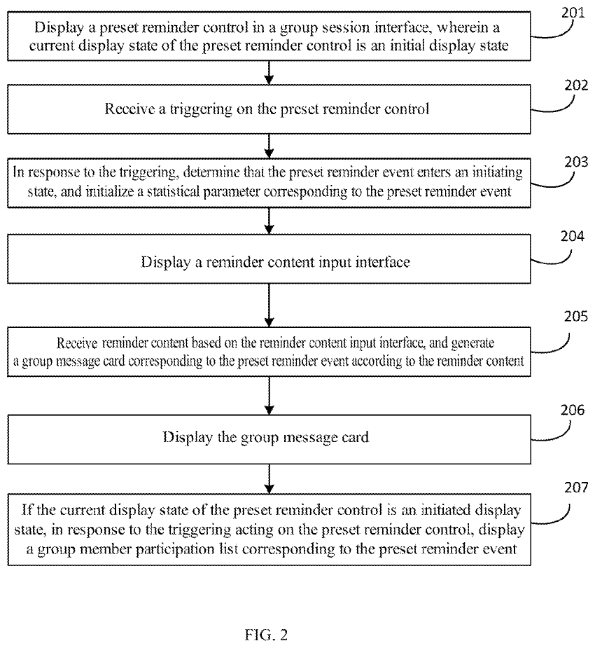

FIG. 2 is a schematic flowchart of a further group interaction method provided in an embodiment of the present disclosure. The embodiment of the present disclosure is described based on the optional solutions in the embodiment described above, taking as an example a login identity corresponding to a group session interface being an initiator of a preset reminder event, in which before the preset reminder event is initiated, any group member in a group other than a group owner may become the initiator. As shown in FIG. 2, the method may comprise:

Step 201, displaying a preset reminder control in a group session interface, wherein a current display state of the preset reminder control is an initial display state.

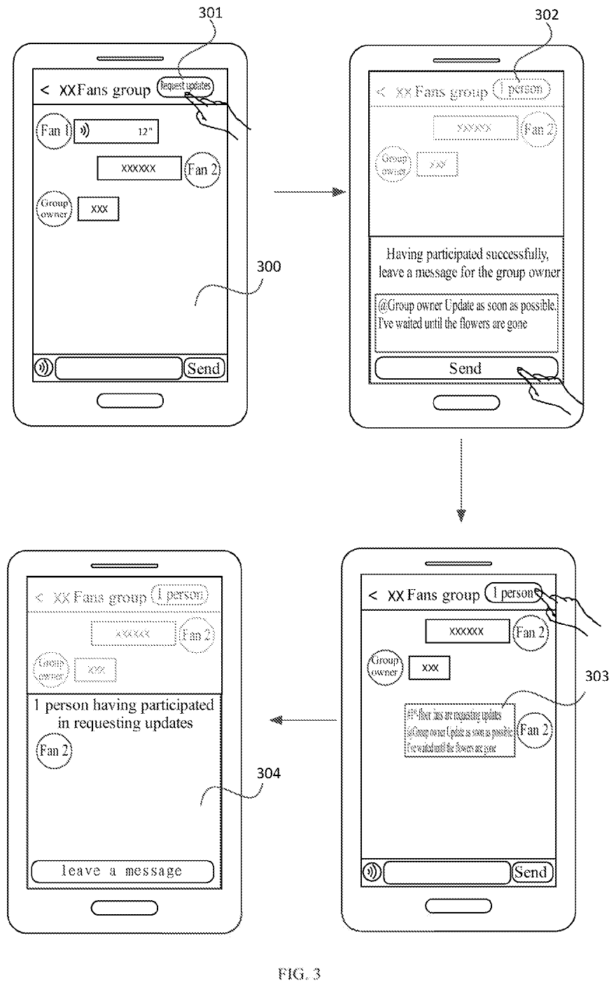

FIG. 3 is a schematic diagram of a group session interface provided in an embodiment of the present disclosure. As shown in FIG. 3, a preset reminder control 301 in an initial display state is displayed at the top of a group session interface 300 and is represented as a “Request updates” button, and this moment is in a reminder period, in which the preset reminder event is not initiated.

If this moment is outside the reminder period, for example, the group owner has just released a new resource, then the preset reminder control is in an ended display state; for example, the “Request updates” button may be gray and cannot be triggered; alternatively, it may be triggered, and after triggering, a reminding operation is performed on the latest resource released by the group owner.

Step 202, receiving a triggering on the preset reminder control.

Illustratively, assuming that the login identity corresponding to the group session interface is fan 2, fan 2 as a user may trigger the preset reminder control by clicking or the like.

Step 203, in response to the triggering, determining that the preset reminder event enters an initiating state, and initializing a statistical parameter corresponding to the preset reminder event.

Illustratively, after fan 2 as a user clicks the preset reminder control 301, the preset reminder event enters the initiating state. Taking as an example the statistical parameter being the number of participants, the initialized number of participants is 1. At this time, the preset reminder control 301 in the initial display state can be changed into a preset reminder control 302 in an initiated display state, which is represented as a “1 person” button, and at this time, 1 represents the number of participants.

After the preset reminder event enters the initiating state, other fans and the group owner in the group can receive corresponding prompts, and the group session interface can also change accordingly. For details, reference can be made to relevant content in the following embodiments.

Step 204, displaying a reminder content input interface.

Optionally, after it is determined that the preset reminder event enters the initiating state, fan 2 may be given a participation success prompt, the reminder content input interface is displayed, and fan 2 can input the words he wants to say to the group owner in the interface.

Step 205, receiving reminder content based on the reminder content input interface, and generating a group message card corresponding to the preset reminder event according to the reminder content.

Illustratively, fan 2 may input “@Group owner Update as soon as possible. I've waited until the flowers are gone” as shown in FIG. 3, and after clicking a “Send” button, a corresponding group message card can be generated. Optionally, the group message card includes reminder content, and a participation serial number that may be represented by a floor number.

Optionally, if fan 2 does not want to input the reminder content, the reminder content input interface can be closed.

Step 206, displaying the group message card.

As shown in FIG. 3, a group message card 303 corresponding to fan 2 is displayed in the group session interface.

Step 207, if the current display state of the preset reminder control is an initiated display state, in response to the triggering acting on the preset reminder control, displaying a group member participation list corresponding to the preset reminder event.

As shown in FIG. 3, after fan 2 triggers the preset reminder control 302 in the initiated display state by clicking or the like, a group member participation list 304 is displayed. Since only fan 2 has participated in the preset reminder event at this time, the list currently includes only fan 2. After other fans have participated in the preset reminder event, the number of participants and the group member participation list are updated accordingly.

According to the group interaction method provided in the embodiment of the present disclosure, the members in the group can initiate the preset reminder event through the preset reminder control, so that a target group member can be conveniently and rapidly reminded to release new resources; in addition, dynamic statistics on the number of participants and viewing of the member participation list can be supported, and the progress of the preset reminder event can be learned dynamically, thereby enhancing the interactivity among the group members.

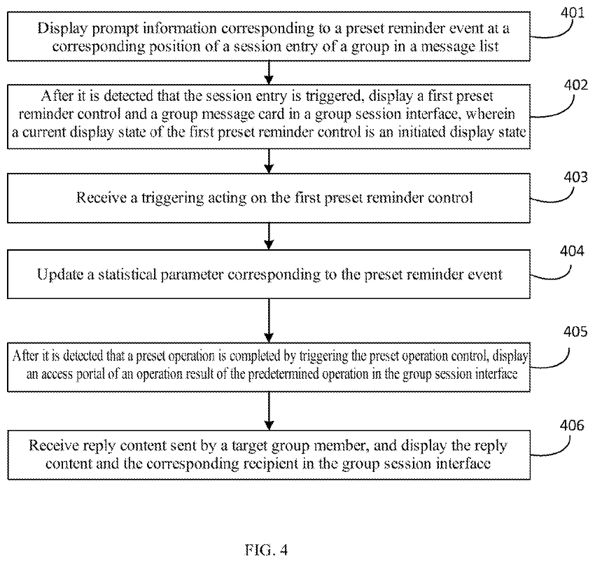

FIG. 4 is a schematic flowchart of a further group interaction method provided in an embodiment of the present disclosure. The embodiment of the present disclosure is described based on the optional solutions in the embodiments described above, taking as an example a login identity corresponding to a group session interface being a supporter of a preset reminder event. As shown in FIG. 4, the method may comprise:

Step 401, displaying prompt information corresponding to a preset reminder event at a corresponding position of a session entry of a group in a message list.

Step 402, after it is detected that the session entry is triggered, displaying a first preset reminder control and a group message card in a group session interface, wherein a current display state of the first preset reminder control is an initiated display state.

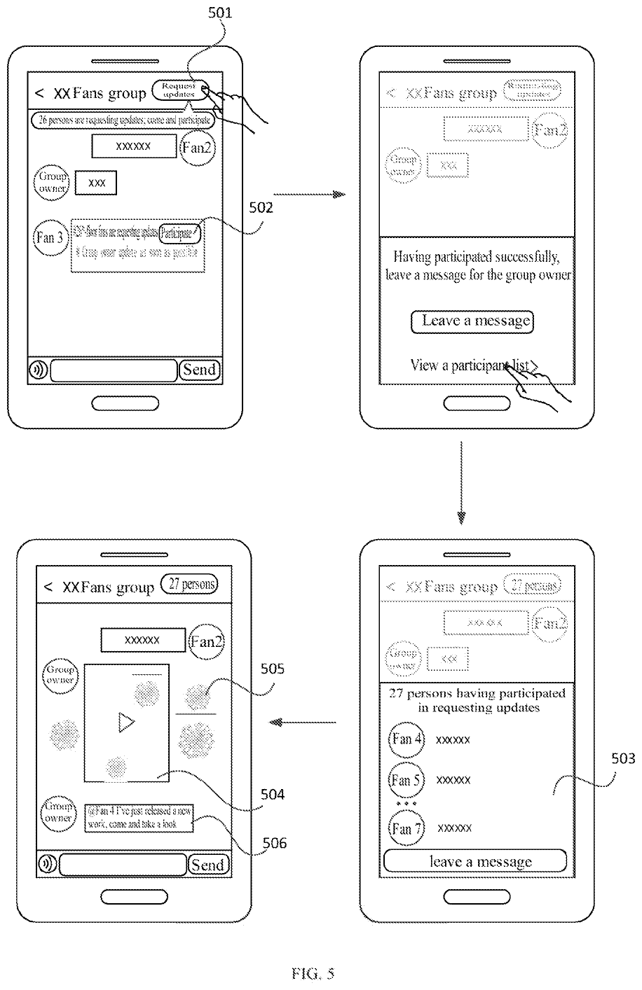

FIG. 5 is a schematic diagram of a further group session interface provided in an embodiment of the present disclosure. As shown in FIG. 5, a first preset reminder control 501 in an initiated display state is displayed at the top of the group session interface and is represented as a “Request updates” button carrying prompt information, where the prompt information is “26 persons are requesting updates; come and participate”, which indicates that there are 26 persons having participated in the preset reminder event at this time.

Optionally, the group session interface may further display a group message card corresponding to a participating group member, which may include reminder content, a participation serial number, and a second preset reminder control. As shown in FIG. 5, the reminder content is “@ group owner Update as soon as possible”, the participation serial number is embodied in the form of a floor number “#26^{th} floor”, a second preset reminder control 502 is also displayed, and for the convenience of being distinguished from the first preset reminder control, the second preset reminder control may be embodied as a “Participate” button here. Optionally, when there are a large number of participating group members, group message cards corresponding to multiple group members may be displayed simultaneously, and at this time, the second preset reminder control may be displayed in the last group message card.

Step 403, receiving a triggering on the first preset reminder control.

Illustratively, assuming that a login identity corresponding to a group session interface is fan 4, fan 4 as a user may trigger the first preset reminder control by clicking or the like, and then a participation success prompt can be displayed. Optionally, a triggering on the second preset reminder control may also be received, and then step 404 is executed.

Step 404, updating a statistical parameter corresponding to the preset reminder event.

The user can also input reminder content by triggering a “Leave a message” button, and view a group member participation list by triggering a “view participation list”.

Illustratively, after fan 4 as a user clicks the “view participation list”, a group member participation list 503 is displayed, and fan 4 can conveniently view relevant conditions of other fans who have participated in the preset reminder event. At this time, since fan 4 has also successfully participated, the number of participants is updated from 26 to 27.

If fan 4 as a user does not input the reminder content, the corresponding group message card may not be displayed.

Step 405, after it is detected that a predetermined operation is completed by triggering the preset operation control, displaying an access portal of an operation result of the predetermined operation in the group session interface.

As shown in FIG. 5, after the group owner releases a new short video, an access portal 504 of the short video is displayed in the group session interface, and fan 4 as a user can quickly watch the short video by clicking the access portal, and in addition, a firework special effect 505 is also played, whereby the interaction effect is improved and the group atmosphere is activated.

Step 406, receiving reply content sent by a target group member, and displaying the reply content and the corresponding recipient in the group session interface.

After the group owner releases the new short video, reply content can be sent to all group members participating in the preset reminder event. However, generally, there are a large number of participants, and in order to avoid disturbing fans, it is not necessary to display all recipients, but to display in a targeted manner. As shown in FIG. 5, since the login identity corresponding to the current group session interface is fan 4, only the recipient is displayed as fan 4, i.e., “@ fan 4”. For other fans, for example, in a group session interface corresponding to fan 7, “@ fan 7” is displayed, so that participants can feel the pertinence of the group owner's reply, thereby improving the interaction effect and enhancing the user stickiness.

According to the group interaction method provided in the embodiment of the present disclosure, the members in the group can receive the prompt after the preset reminder event enters the initiating state, can conveniently participate in the preset reminder event by triggering the preset reminder control after entering the group session interface, can further view the participation situation, and when the group owner releases a new resource in response to the preset reminder event, can quickly view it in the group session interface and receive the reply content of the group owner in a targeted manner. By means of this, the interactivity among the group members can be effectively enhanced, the group atmosphere can be activated, the user stickiness can be enhanced, and the enthusiasm of resource publishers for releasing new resources can be improved.

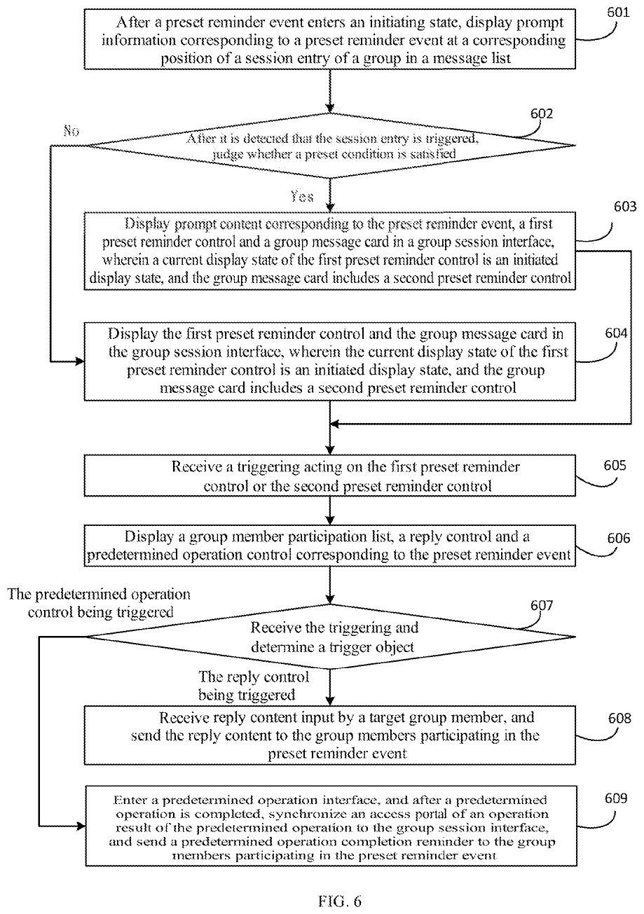

FIG. 6 is a schematic flowchart of a further group interaction method provided in an embodiment of the present disclosure. The embodiment of the present disclosure is described based on the optional solutions in the embodiments described above, taking as an example a login identity corresponding to a group session interface being a target group member, the method comprising:

Step 601, after a preset reminder event enters an initiating state, displaying prompt information corresponding to the preset reminder event at a corresponding position of a session entry of a group in a message list.

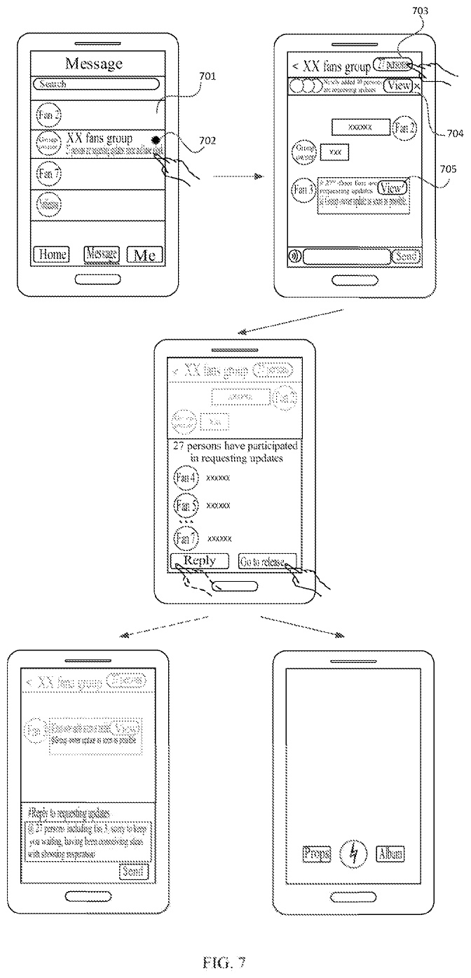

FIG. 7 is a schematic diagram of a further group session interface provided in an embodiment of the present disclosure. As shown in FIG. 7, after a preset reminder event enters an initiating state, if a group owner does not enter a group session interface in a reminder period of this time, prompt information 702 can be displayed on the right side of a session entry of a group in a message list 701, where the prompt message may include a red dot and/or text information.

Optionally, after the preset reminder event enters the initiating state, the number of display times of the prompt information can be preset, such as 1, in one reminder period. When the prompt information is not displayed, the group session interface can also be entered by triggering the session entry.

Step 602, after it is detected that the session entry is triggered, judging whether a preset condition is satisfied, and if the preset condition is satisfied, executing step 603; if the preset condition is not satisfied, proceeding to step 604.

Illustratively, the preset condition includes when the preset reminder event enters the initiating state, or that a difference value of a current value of a statistical parameter corresponding to the preset reminder event from a historical value when the group session interface was displayed last time is greater than a preset difference threshold value. For example, after the preset reminder event enters the initiating state, the group owner opens the group session interface for the first time, and it can be considered that the preset condition is satisfied. For another example, taking the number of participants as an example, if there are 10 newly-added participants since the group conversation interface was opened in a group last time, it can be considered that the preset condition is satisfied.

Step 603, displaying prompt content corresponding to the preset reminder event, a first preset reminder control and a group message card in a group session interface, wherein a current display state of the first preset reminder control is an initiated display state, and the group message card includes a second preset reminder control.

Illustratively, the prompt content is presented in the form of a floating bar, and can be closed by clicking a close control (e.g., “x”). The prompt content may include avatars and the number of newly-added participants, and may further include a third preset reminder control 704. By triggering the third preset reminder control 704, a group member participation list can be displayed.

Step 604, displaying the first preset reminder control and the group message card in the group session interface, wherein the current display state of the first preset reminder control is an initiated display state, and the group message card includes a second preset reminder control.

As shown in FIG. 7, for the group owner, a first preset reminder control 703 is displayed in the group session interface, and the display content at this time is the number of participants; the group message card includes a second preset reminder control 705, and the display content at this time is “View”.

Step 605, receiving a triggering on the first preset reminder control or the second preset reminder control.

Illustratively, the group owner may choose to trigger the first preset reminder control or the second preset reminder control according to personal habits.

Step 606, displaying a group member participation list, a reply control and a predetermined operation control corresponding to the preset reminder event.

As shown in FIG. 7, after the group owner triggers the first preset reminder control, a group member participation list, a reply control, and a resource release control are displayed. A plurality of items in the group member participation list may include group member names, group member avatars, group member ranks, and relationship information between group members and target group members, and different participant-related information can be viewed by sliding. If the group owner does not want to release new resources at this time, he may choose to trigger a reply button to appease the participants. If the group owner immediately releases a new resource for meeting the fans' requirements at this time, he may choose to trigger a resource release button.

Step 607, receiving the triggering and determining a trigger object, if it is detected that the reply control is triggered, executing step 608, and if it is detected that a predetermined operation control is triggered, executing step 609.

Step 608, receiving reply content input by a target group member, and sending the reply content to the group members participating in the preset reminder event.

Illustratively, as shown in FIG. 7, if the group owner chooses to trigger the “reply” button, he can automatically @ the participating fans and input the reply content. After clicking “Send”, the reply content can be sent to 27 fans requesting updates.

Step 609, entering a predetermined operation interface, and after a predetermined operation is completed, synchronizing an access portal of an operation result of the predetermined operation to the group session interface, and sending a predetermined operation completion reminder to the group members participating in the preset reminder event.

Taking short videos as an example, as shown in FIG. 7, if the group owner chooses to trigger a “Go to release” button, he can enter a video shooting interface and shoot a new short video. If the preset reminder event is to remind the group owner to start broadcasting, the resource release control can be “Go to broadcast”, and after the group owner chooses to trigger the “Go to broadcast” button, he can enter a video live broadcast interface and start live broadcast.

If the group owner completes the release of a new resource by triggering the resource release control, in order to better respond to the participants, the access portal of the new resource can be synchronized to the group session interface, and a new resource release reminder is sent to the group members participating in the preset reminder event to remind the participants to view.

According to the group interaction method provided by the embodiment of the present disclosure, after members in a group participate in the preset reminder event, the group owner can receive prompts in time, conveniently view relevant conditions of the participants by triggering the preset reminder control after entering the group session interface, can: respond to the participants by selecting message reply or release of new resources, and remind the participants of the reply or release of new resources in a targeted manner, so that the interactivity between the group owner and the fans is effectively enhanced, the group atmosphere is activated, the user stickiness is enhanced, and the enthusiasm of the group owner for releasing new resources is improved.

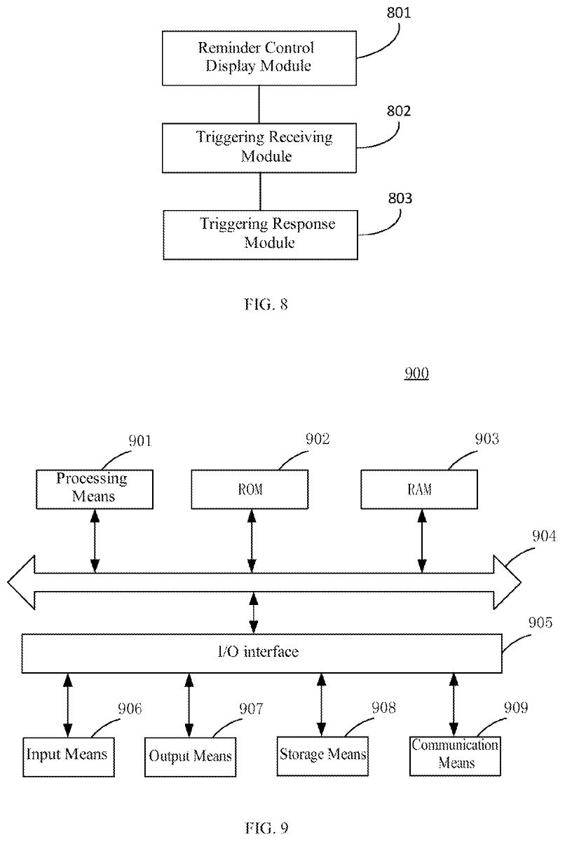

FIG. 8 is a block diagram of a group interaction apparatus provided in an embodiment of the present disclosure. The apparatus can be implemented by software and/or hardware, generally integrated in an electronic device, and can perform group interaction by executing a group interaction method. As shown in FIG. 8, the apparatus comprises:
a reminder control display module 801 configured to display a preset reminder control in a group session interface, wherein the preset reminder control is configured for triggering a relevant operation of a preset reminder event, and the preset reminder event comprises reminding a target group member in a group to complete a predetermined operation; a triggering receiving module 802 configured to receive a triggering on the preset reminder control; and a triggering response module 803 configured to respond to the triggering.

The group interaction apparatus provided in the embodiment of the present disclosure displays a preset reminder control in a group session interface, wherein the preset reminder control is configured for triggering a relevant operation of a preset reminder event, and the preset reminder event comprises reminding a target group member in a group to complete a predetermined operation; the apparatus receives a triggering on the preset reminder control, and responds to the triggering. By adopting the technical solution described above, the group members can participate in the preset reminder event by triggering the preset reminder control in the group session interface, and a target group member in the group is reminded to complete the predetermined operation, so that the forms of interaction among the group members can be enriched, the interaction efficiency can be improved, and the reminding effect of the predetermined operation can be improved.

Optionally, the triggering response module 803 is configured to: display a reminder content input interface, receive reminder content based on the reminder content input interface, and generate a group message card corresponding to the preset reminder event according to the reminder content, wherein the group message card includes the reminder content; and to display the group message card.

Optionally, the group message card further includes at least one of: a participation serial number corresponding to a group member who inputs the reminder content, a group card preset reminder control, or a current value of a statistical parameter corresponding to the preset reminder event, wherein the preset reminder control includes the group card preset reminder control.

Optionally, the triggering response module 803 is configured to: respond to the triggering according to a current display state of the preset reminder control.

Optionally, the triggering response module 803 is configured to: if the current display state of the preset reminder control is non-triggered, in response to the triggering, determine and/or display a statistical parameter corresponding to the preset reminder event.

Optionally, the triggering response module 803 is configured to: if the current display state of the preset reminder control is an initial display state, in response to the triggering, determine that the preset reminder event enters an initiating state, and initialize the statistical parameter corresponding to the preset reminder event, wherein the statistical parameter includes the number of participants and/or the number of participations.

Optionally, the triggering response module 803 is configured to: if the current display state of the preset reminder control is an initiated display state, in response to the triggering, update the statistical parameter corresponding to the preset reminder event, wherein the display content corresponding to the initiated display state includes a current value of the statistical parameter.

Optionally, the triggering response module 803 is configured to: if the current display state of the preset reminder control is an ended display state, in response to the triggering, display a prompt for the target group member to complete a predetermined operation, wherein if the current moment is in a shielding period corresponding to the preset reminder event, the preset reminder control is in the ended display state.

Optionally, the triggering response module 803 is configured to: if the current display state of the preset reminder control is triggered, in response to the triggering, displaying a group member participation list corresponding to the preset reminder event.

Optionally, the apparatus may further comprise: a first prompt information display module configured to, after the preset reminder event enters the initiating state, if a group session interface is not viewed by current group members, display first prompt information corresponding to the preset reminder event at a corresponding position of a session entry of the group in a message list.

Optionally, the apparatus may further comprise: prompt content display module configured to, if a login identity corresponding to the group session interface is the target group member, display prompt content corresponding to the preset reminder event in the group session interface when a preset condition is satisfied, wherein the preset condition includes when the preset reminder event enters the initiating state, or that a difference value of the current value of the statistical parameter corresponding to the preset reminder event from a historical value when the group session interface was displayed last time is greater than a preset difference threshold value.

Optionally, the apparatus may further comprise: a control display module configured to, if the login identity corresponding to the group session interface is the target group member and the preset reminder event is in the initiating state, display a viewing control and/or a predetermined operation control in the group session interface, wherein the viewing control is configured for viewing the group members participating in the preset reminder event, and the predetermined operation control includes a trigger portal for completing the predetermined operation.

Optionally, the apparatus may further comprise: a predetermined operation completion reminding module configured to, after it is detected that the predetermined operation is completed by triggering the predetermined operation control, send a predetermined operation completion reminder to the group members participating in the preset reminder event.

Optionally, the triggering response module 803 is configured to: display a virtual resource configuration interface; receive virtual resource configuration information input by a current group member, wherein the virtual resource configuration information is configured for configuring virtual resources transferred from the current group member to the target group member if the target group member completes a predetermined operation by triggering the predetermined operation control.

Optionally, the apparatus may further comprise: a synchronization module configured to, after it is detected that the predetermined operation is completed by triggering the predetermined operation control, synchronize an operation result of the predetermined operation to the group session interface, and display second prompt information in the group session interface, wherein the second prompt information is configured for identifying virtual resources obtained by the target group member based on the predetermined operation, and the virtual resources are transferred to the target group member from the group members participating in the preset reminder event.

Optionally, the apparatus may further comprise:
a reply control display module configured to, if the login identity corresponding to the group session interface is the target group member and the preset reminder event is in the initiating state, display a reply control corresponding to the preset reminder event in the group session interface; and a reply content sending module configured to, after it is detected that the reply control is triggered, receive reply content input by the target group member, and send the reply content to the group members participating in the preset reminder event.

Optionally, the apparatus may further comprise: a recipient display module configured to, if the login identity corresponding to the group session interface is a first group member participating in the preset reminder event, display the reply content and a recipient corresponding to the reply content in the group session interface, wherein the recipient is the first group member, and/or the recipient does not comprise a second group member participating in the preset reminder event.

Referring now to FIG. 9, shown is a block diagram of an electronic device 900 suitable for use in implementing an embodiment of the present disclosure. The electronic device 900 in the embodiment of the present disclosure may comprise, but is not limited to, mobile terminals such as a mobile phone, a notebook computer, a Digital 1 broadcast receiver, a Personal Digital Assistant (PDA), a tablet computer (PAD), a Portable Multimedia Player (PMP), a vehicle-mounted terminal (e.g., vehicle-mounted navigation terminal), and the like, and fixed terminals such as a Digital Television (TV), a desktop computer, and the like. The electronic device 900 shown in FIG. 9 is only an example and should not bring any limitations to the functionality and scope of use of the embodiment of the present disclosure.

As shown in FIG. 9, the electronic device 900 may comprise processing means (e.g., central processing unit, graphics processor, etc.) 901 that may perform various suitable actions and processes in accordance with programs stored in a Read-Only Memory (ROM) 902 or loaded from storage means 908 into a Random Access Memory (RAM) 903. In the RAM 903, various programs and data necessary for operations of the electronic device 900 are also stored. The processing means 901, ROM 902, and RAM 903 are connected to each other via a bus 904. An Input/Output (I/O) interface 905 is also connected to the bus 904.

Generally, the following means may be connected to the I/O interface 905: input means 906 including, for example, a touch screen, a touch pad, a keyboard, a mouse, a camera, a microphone, an accelerometer, a gyroscope, and the like; output means 907 including, for example, a Liquid Crystal Display (LCD), a speaker, a vibrator, and the like; storage means 906 including, for example, a magnetic tape, a hard disk, and the like; and communication means 909. The communication means 909 may allow the electronic device 900 to perform wireless or wired communication with other devices to exchange data. While FIG. 9 illustrates the electronic device 900 having various means, not all illustrated means are required to be implemented or provided. More or fewer means may be alternatively implemented or provided.

According to an embodiment of the present disclosure, the processes described above with reference to the flow charts may be implemented as computer software programs. For example, the embodiment of the present disclosure comprises a computer program product comprising a computer program carried on a non-transitory computer readable medium, the computer program containing program code for performing the method illustrated by the flow chart. In such an embodiment, the computer program may be downloaded and installed from a network through the communication means 909, or installed from the storage means 908, or installed from the ROM 902. The computer program, when executed by the processing means 901, performs the above-described functions defined in the methods of the embodiments of the present disclosure.

The computer readable medium of the present disclosure may be a computer readable signal medium or a computer readable storage medium or any combination thereof. The computer readable storage medium may be, for example, but not limited to, an electronic, magnetic, optical, electromagnetic, infrared, or semiconductor system, apparatus, or device, or any combination of the foregoing. Examples of a computer readable storage medium may include, but are not limited to: an electrical connection having one or more wires, a portable computer diskette, a hard disk, a RAM, a ROM, an Erasable Programmable Read-Only Memory (EPROM or flash Memory), an optical fiber, a portable Compact Disc Read-Only Memory (CD-ROM), an optical storage device, a magnetic storage device, or any suitable combination of the foregoing. In the present disclosure, a computer readable storage medium may be any tangible medium that can contain, or store a program for use by or in connection with an instruction execution system, apparatus, or device. In contrast, in the present disclosure, a computer readable signal medium may include a propagated data signal with computer readable program code embodied therein, for example, in baseband or as part of a carrier wave. Such a propagated data signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to: electrical wires, optical cables, Radio Frequency (RF), and the like, or any suitable combination of the foregoing.

The computer readable medium may be embodied in the electronic device; or may be separate and not incorporated into the electronic device.

The computer readable medium carries one or more programs which, when executed by the electronic device, cause the electronic device to: display a preset reminder control in a group session interface, wherein the preset reminder control is configured for triggering a relevant operation of a preset reminder event, and the preset reminder event comprises reminding a target group member in a group to complete a predetermined operation; receive a triggering on the preset reminder control; and respond to the triggering.

Computer program code for carrying out operations for aspects of the present disclosure may be written in any combination of one or more programming languages, including but not limited to an object oriented programming language such as Java, Smalltalk, C++, including conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a Local Area Network (LAN) or a Wide Area Network (WAN), or the connection may be made to an external computer (for example, through the Internet using an Internet service provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules described in the embodiments of the present disclosure may be implemented by software or hardware. Where the name of a module does not constitute a limitation on the module itself in one case, for example, a trigger action response module may also be described as a “module that responds to the trigger action”.

The functions described herein above may be performed, at least in part, by one or more hardware logic components. For example, without limitation, exemplary types of hardware logic components that may be used include: field Programmable Gate Arrays (FPGAs), Application Specific Integrated Circuits (ASICs), Application Specific Standard Parts (ASSPs), System On Chip (SOCs), Complex Programmable Logic Devices (CPLDs), and so forth.

In the context of the present disclosure, a machine-readable medium may be a tangible medium that can contain, or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. Examples of a machine-readable storage medium may include an electrical connection based on one or more wires, a portable computer diskette, a hard disk, a RAM, a ROM, an EPROM or flash memory, an optical fiber, a CD-ROM, an optical storage device, a magnetic storage device, or any suitable combination of the foregoing.

According to one or more embodiments of the present disclosure, there is provided a group interaction method, comprising:
displaying a preset reminder control in a group session interface, wherein the preset reminder control is configured for triggering a relevant operation of a preset reminder event, and the preset reminder event comprises reminding a target group member in a group to complete a predetermined operation;
receiving a triggering on the preset reminder control;
responding to the triggering.

In an embodiment, the responding to the triggering comprises: displaying a reminder content input interface; receiving reminder content based on the reminder content input interface, and generating a group message card corresponding to the preset reminder event according to the reminder content, wherein the group message card includes the reminder content; and displaying the group message card.

In an embodiment, the group message card further includes at least one of: a participation serial number corresponding to a group member who inputs the reminder content, a group card preset reminder control, or a current value of a statistical parameter corresponding to the preset reminder event, wherein the preset reminder control includes the group card preset reminder control.

In an embodiment, the responding to the triggering comprises: responding to the triggering according to a current display state of the preset reminder control.

In an embodiment, the responding to the triggering according to a current display state of the preset reminder control comprises: if the current display state of the preset reminder control is non-triggered, in response to the triggering, determining and/or displaying a statistical parameter corresponding to the preset reminder event.

In an embodiment, the responding to the triggering according to a current display state of the preset reminder control comprises: if the current display state of the preset reminder control is an initial display state, in response to the triggering, determining that the preset reminder event enters an initiating state, and initializing the statistical parameter corresponding to the preset reminder event, wherein the statistical parameter includes the number of participants and/or the number of participations.

In an embodiment, the responding to the triggering according to a current display state of the preset reminder control comprises: if the current display state of the preset reminder control is an initiated display state, in response to the triggering, updating the statistical parameter corresponding to the preset reminder event, wherein the display content corresponding to the initiated display state includes a current value of the statistical parameter.

In an embodiment, the responding to the triggering according to a current display state of the preset reminder control comprises: if the current display state of the preset reminder control is an ended display state, in response to the triggering, displaying a prompt for the target group member to complete a predetermined operation, wherein if the current moment is in a shielding period corresponding to the preset reminder event, the preset reminder control is in the ended display state.

In an embodiment, the responding to the triggering according to a current display state of the preset reminder control comprises: if the current display state of the preset reminder control is triggered, in response to the triggering, displaying a group member participation list corresponding to the preset reminder event.

In an embodiment, there further comprises: after the preset reminder event enters the initiating state, if the group session interface is not viewed by current group members, displaying first prompt information corresponding to the preset reminder event at a corresponding position of a session entry of the group in a message list.

In an embodiment, there further comprises: if a login identity corresponding to the group session interface is the target group member, displaying prompt content corresponding to the preset reminder event in the group session interface when a preset condition is satisfied, wherein the preset condition includes when the preset reminder event enters the initiating state, or that a difference value of the current value of the statistical parameter corresponding to the preset reminder event from a historical value when the group session interface was displayed last time is greater than a preset difference threshold value.

In an embodiment, there further comprises: if the login identity corresponding to the group session interface is the target group member and the preset reminder event is in the initiating state, displaying a viewing control and/or a predetermined operation control in the group session interface, wherein the viewing control is configured for viewing group members participating in the preset reminder event, and the predetermined operation control includes a trigger portal for completing the predetermined operation.

In an embodiment, there further comprises: after it is detected that the predetermined operation is completed by triggering the predetermined operation control, sending a predetermined operation completion reminder to the group members participating in the preset reminder event.

In an embodiment, the responding to the triggering comprises: displaying a virtual resource configuration interface; receiving virtual resource configuration information input by a current group member, wherein the virtual resource configuration information is configured for configuring virtual resources transferred from the current group member to the target group member if the target group member completes the predetermined operation.

In an embodiment, there further comprises: after it is detected that the predetermined operation is completed by triggering the predetermined operation control, synchronizing an operation result of the predetermined operation to the group session interface, and displaying second prompt information in the group session interface, wherein the second prompt information is configured for identifying virtual resources obtained by the target group member based on the predetermined operation, and the virtual resources are transferred to the target group member from the group members participating in the preset reminder event.

In an embodiment, there further comprises: if the login identity corresponding to the group session interface is the target group member and the preset reminder event is in the initiating state, displaying a reply control corresponding to the preset reminder event in the group session interface; and after it is detected that the reply control is triggered, receiving reply content input by the target group member, and sending the reply content to the group members participating in the preset reminder event.

In an embodiment, there further comprises: if the login identity corresponding to the group session interface is a first group member participating in the preset reminder event, displaying the reply content and a recipient corresponding to the reply content in the group session interface, wherein the recipient is the first group member, and/or the recipient does not comprise a second group member participating in the preset reminder event.

According to one or more embodiments of the present disclosure, there is provided a group interaction apparatus, comprising:
a reminder control display module configured to display a preset reminder control in a group session interface, wherein the preset reminder control is configured for triggering a relevant operation of a preset reminder event, and the preset reminder event comprises reminding a target group member in a group to complete a predetermined operation;
a triggering receiving module configured to receive a triggering on the preset reminder control; and
a triggering response module configured to respond to the triggering.

Further, while operations are depicted in a particular order, this should not be understood as requiring that such operations be performed in the particular order shown or in sequential order. Under certain circumstances, multitasking and parallel processing may be advantageous. Likewise, while numerous implementation details are included in the above discussion, these should not be construed as limitations on the scope of the disclosure. Some features that are described in the context of separate embodiments may also be implemented in combination in a single embodiment. Conversely, various features that are described in the context of a single embodiment can also be implemented in multiple embodiments separately or in any suitable subcombination.

1. A group interaction method, comprising:
displaying a preset reminder control in a group session interface, wherein the preset reminder control is configured for triggering a relevant operation of a preset reminder event, and the preset reminder event comprises reminding a target group member in a group to complete a predetermined operation;
receiving a triggering on the preset reminder control; and
responding to the triggering.

2. The method according to claim 1, wherein the responding to the triggering comprises:
displaying a reminder content input interface;
receiving reminder content based on the reminder content input interface, and generating a group message card corresponding to the preset reminder event according to the reminder content, wherein the group message card includes the reminder content; and
displaying the group message card.

3. The method according to claim 2, wherein the group message card further includes at least one of: a participation serial number corresponding to a group member who inputs the reminder content, a group card preset reminder control, or a current value of a statistical parameter corresponding to the preset reminder event, wherein the preset reminder control includes the group card preset reminder control, and the statistical parameter includes at least one of the number of participants or the number of participations.

4. The method according to claim 1, wherein the responding to the triggering comprises:
responding to the triggering according to a current display state of the preset reminder control.

5. The method according to claim 4, wherein the responding to the triggering according to a current display state of the preset reminder control comprises:
if the current display state of the preset reminder control is non-triggered, in response to the triggering, performing at least one of: determining a statistical parameter corresponding to the preset reminder event; or displaying the statistical parameter corresponding to the preset reminder event.

6. The method according to claim 5, wherein the responding to the triggering according to a current display state of the preset reminder control comprises:
if the current display state of the preset reminder control is an initial display state, in response to the triggering, determining that the preset reminder event enters an initiating state, and initializing the statistical parameter corresponding to the preset reminder event, wherein the statistical parameter includes at least one of the number of participants or the number of participations.

7. The method according to claim 5, wherein the responding to the triggering according to a current display state of the preset reminder control comprises:
if the current display state of the preset reminder control is an initiated display state, in response to the triggering, updating the statistical parameter corresponding to the preset reminder event, wherein the display content corresponding to the initiated display state includes a current value of the statistical parameter.

8. The method according to claim 4, wherein the responding to the triggering according to a current display state of the preset reminder control comprises:
if the current display state of the preset reminder control is an ended display state, in response to the triggering, displaying a prompt for the target group member to complete a predetermined operation, wherein if the current moment is in a shielding period corresponding to the preset reminder event, the preset reminder control is in the ended display state.

9. The method according to claim 4, wherein the responding to the triggering according to a current display state of the preset reminder control comprises:
if the current display state of the preset reminder control is triggered, in response to the triggering, displaying a group member participation list corresponding to the preset reminder event.

10. The method according to claim 1, further comprising:
after the preset reminder event enters an initiating state, if the group session interface is not viewed by current group members, displaying first prompt information corresponding to the preset reminder event at a corresponding position of a session entry of the group in a message list.

11. The method according to claim 1, further comprising:
if a login identity corresponding to the group session interface is the target group member and a preset condition is satisfied, displaying prompt content corresponding to the preset reminder event in the group session interface, wherein the preset condition includes when the preset reminder event enters the initiating state, or that a difference value of the current value of the statistical parameter corresponding to the preset reminder event from a historical value when the group session interface was displayed last time is greater than a preset difference threshold value.

12. The method according to claim 1, further comprising:
if the login identity corresponding to the group session interface is the target group member and the preset reminder event is in the initiating state, displaying at least one of a viewing control or a predetermined operation control in the group session interface, wherein the viewing control is configured for viewing corresponding group members participating in the preset reminder event, and the predetermined operation control includes a trigger portal for completing the predetermined operation.

13. The method according to claim 12, further comprising:
after it is detected that the predetermined operation is completed by triggering the predetermined operation control, sending a predetermined operation completion reminder to the group members participating in the preset reminder event.

14. The method according to claim 1, wherein the responding to the triggering comprises:
displaying a virtual resource configuration interface;
receiving virtual resource configuration information input by a current group member, wherein the virtual resource configuration information is configured for configuring virtual resources transferred from the current group member to the target group member if the target group member completes the predetermined operation.

15. The method according to claim 14, further comprising:
after it is detected that the predetermined operation is completed by triggering the predetermined operation control, synchronizing an operation result of the predetermined operation to the group session interface, and displaying second prompt information in the group session interface, wherein the second prompt information is configured for identifying virtual resources obtained by the target group member based on the predetermined operation, and the virtual resources are transferred to the target group member from the group members participating in the preset reminder event.

16. The method according to claim 1, further comprising:
if the login identity corresponding to the group session interface is the target group member and the preset reminder event is in the initiating state, displaying a reply control corresponding to the preset reminder event in the group session interface; and
after it is detected that the reply control is triggered, receiving reply content input by the target group member, and sending the reply content to the group members participating in the preset reminder event.

17. The method according to claim 16, further comprising:
if the login identity corresponding to the group session interface is a first group member participating in the preset reminder event, displaying the reply content and a recipient corresponding to the reply content in the group session interface, wherein the recipient satisfies at least one of the following: the recipient is the first group member; or the recipient does not comprise a second group member participating in the preset reminder event.

18. (canceled)

19. An electronic device, comprising a memory, a processor, and a computer program stored in the memory and executable on the processor, wherein the processor, when executing the computer program, implements a group interaction method, comprising:
displaying a preset reminder control in a group session interface, wherein the preset reminder control is configured for triggering a relevant operation of a preset reminder event, and the preset reminder event comprises reminding a target group member in a group to complete a predetermined operation;
receiving a triggering on the preset reminder control; and
responding to the triggering.

20. (canceled)

21. The electronic device according to claim 19, wherein the responding to the triggering comprises:
displaying a reminder content input interface;
receiving reminder content based on the reminder content input interface, and generating a group message card corresponding to the preset reminder event according to the reminder content, wherein the group message card includes the reminder content; and
displaying the group message card.

22. A non-transitory computer-readable storage medium on which a computer program is stored, wherein the program, when executed by a processor, implements a group interaction method, comprising:
displaying a preset reminder control in a group session interface, wherein the preset reminder control is configured for triggering a relevant operation of a preset reminder event, and the preset reminder event comprises reminding a target group member in a group to complete a predetermined operation;
receiving a triggering on the preset reminder control; and
responding to the triggering.
